(19) United States
(12) Patent Application Publication
(10) Pub. No.: US 2021/0336492 A1
(43) Pub. Date: Oct. 28, 2021

(54) WIRELESS CHARGING

(71) Applicant: Hewlett-Packard Development Company, L.P., Spring, TX (US)

(72) Inventor: Chia Hua CHU, Taipei City (TW)

(21) Appl. No.: 16/481,222

(22) PCT Filed: Feb. 12, 2018
(86) PCT No.: PCT/US2018/017803

§ 371 Date: Jul. 26, 2019

(51) Int. Cl. H02J 50/90; H02J 50/00; H02J 7/00

(52) U.S. Cl. CPC H02J 50/90; H02J 7/0047; H02J 7/00034; H02J 50/005

(57) ABSTRACT

Examples of charging devices, apparatus and stations for wirelessly charging an electronic device, are described. In one example, the charging device may include a positioning mechanism coupled to power transmitter. The positioning mechanism adjusts a position of the power transmitter to change a perpendicular distance between the plane of the power transmitter and a charging surface of the charging device.

### BACKGROUND

Wireless charging devices allow charging an electronic device without it being physically coupled through an electric cable to a charger. A wireless charging device may include a power transmitter, such as a primary coil, which interacts with a power receiver, such as secondary coil within the electronic device. The interaction between the power transmitter and the power receiver enables wireless transfer of electrical power. The electrical power in turn may charge a chargeable power source within the electronic device.

### BRIEF DESCRIPTION OF THE DRAWINGS

The following detailed description references the drawings, wherein:

FIG. 1 is a block diagram of an example charging device;

FIG. 2 is a block diagram of another example charging device;

FIG. 3 is a block diagram of an example wireless charging apparatus;

FIG. 4 is a block diagram of an example wireless charging station; and

FIG. 5 is a block diagram of another example wireless charging station.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Wireless charging devices (referred to as a charging device) enable wireless transfer of energy from an electrical source to an electronic device. Such wireless charging devices may include a wireless power transmitter which interacts wirelessly with a corresponding wireless power receiver present within the electronic device. When the electronic device, and hence the wireless power receiver (referred to as the power receiver), is present within a predefined distance, the interaction between the wireless power transmitter (referred to as the power transmitter) generates electrical power for charging the electronic device. The interaction between the power transmitter and the power receiver may depend on components which are utilized for implementing the power transmitter and the power receiver. Certain examples of such interactions include, but not limited to, electromagnetic, electrodynamic, electrostatic, and magneto-dynamic.

For example, in the charging device the power transmitter may be implemented as a primary induction coil which interacts with a corresponding power receiver or a secondary coil present within the electronic device. When electrical power is applied to the charging device, an electromagnetic field is generated in the primary coil. Through electromagnetic induction, a corresponding electromagnetic field is generated in the secondary coil of the electronic device. The electromagnetic field in the secondary coil results in generation of electrical power which may then be used for charging a power source within the electronic device.

The charging device may generally have a housing which encloses the power transmitter, and other internal circuitry. For charging, an electronic device may be placed on a designated surface of the charging device. The designated surface, referred to as a charging surface, is generally the surface beneath which the power transmitter of the charging device is positioned. For charging efficiently, the electronic device (and the power receiver) may be positioned onto the charging device, such that the power receiver is appropriately aligned with the power transmitter during charging.

It may be the case that even if the power transmitter and the power receiver are aligned, they may yet be separated by an effective vertical distance which in turn limits efficient charging of the electronic device. The efficiency of the charging process (or the charging efficiency) may not be optimal, if the distance between the power transmitter and the power receiver is greater than a threshold distance. Charging efficiency may be considered optimal if the distance between the power transmitter and the power receiver is within a specific range. Charging efficiency may be considered, in one example, as a ratio of the power generated by the power receiver to the value of input power being provided to the power transmitter.

In the present instance, the power generated by the power receiver may be dependent on an active charging area of the power transmitter. The active charging area, in turn, may be defined as a surface area on the charging surface of the charging device, within which the charging efficiency is greater than a specific value when the electronic device is placed. If the distance between the power transmitter and the power receiver is not within the specific range, the charging efficiency may be low. For example, an increase in the vertical distance between the power transmitter and the power receiver may decrease the active charging area of the charging device. In a similar manner, the charging efficiency may be effected, if the power transmitter is too close to the power receiver.

The active charging area may be considered to include a number of smaller notional regions. Regions within the central portion of the active charging area may have a higher charging efficiency as compared to the regions present closer to the edge of the active charging area. A notional centre of the active charging area may coincide with a centre of the power transmitter of the charging device. In such cases, if the distance between the power transmitter and the power receiver increases beyond or is less than the specific range, the active charging area may decrease. This may impact the charging efficiency of the charging device.

The effective vertical distances between the power transmitter and the power receiver may change owing to a variety of factors. For example, electronic devices such as mobile phones or tablet-based computing device may be covered using an additional after-market protective case. The protective case may have a thickness. As a result, the vertical distance between the power transmitter and the power receiver may be greater as compared to instances where the electronic device without any cover is placed over the charging device. The protective case having other components, such as a kick-stand, may further increase the effective distance between the power transmitter of the charging device and the power receiver of the electronic device. Furthermore, different electronic devices may have power receivers with different configurations. Consequently, the specific range with respect to the power transmitter for such electronic devices may vary. As a result, the same charging device may not provide a similar charging efficiency for different electronic devices.

A charging device with an adjustable power transmitter is described. In one example, the charging device may include a positioning mechanism coupled with a power transmitter of the charging device. The positioning mechanism is such that it adjusts a position of the power transmitter with respect to a charging surface of the charging device. In the present example, the plane of the power transmitter may be such that it extends along the inner portion of the charging surface. In operation, the positioning mechanism changes the position of the power transmitter such that the perpendicular distance between the plane of the power transmitter and the charging surface may be changed. The positioning mechanism may be either mechanical or electro-mechanical. In one example, the positioning mechanism is manually actuated by a user.

A user of an electronic device may actuate the positioning mechanism on detecting that the charging efficiency is low. The charging efficiency may be indicated through a visual indicator (such as a display) or an audio indicator (such as an audio speaker). On determining the charging efficiency to be low, the user may actuate the positioning mechanism such that the power transmitter is moves either closer to or away from the charging surface of the charging device such that the position of the power transmitter is within the specific range. As the power transmitter is adjusted to a position which lies in the specific range, the active charging area increases and hence, the charging efficiency increases as well.

The present approaches for increasing the charging efficiency by adjusting the position of the power transmitter are not complex and may be implemented through a variety of mechanisms. Furthermore, the present subject matter does not involve either changing the design and configuration of the power transmitter, nor involves implementing any changes to the internal circuitry of the charging device.

In another aspect of the present subject matter, the charging device may further include an indicator to generate a charging efficiency indication. The charging efficiency indication may indicate a value representing charging efficiency of the charging device at any instant. The charging efficiency indication may be either a visual or an audio indication. In one example, the electronic device being charged may determine the value of electrical power being generated by its power receiver. The information pertaining to the value of electrical power is communicated to the charging device over a wireless communication channel between the charging device and the electronic device. On receiving the electrical power information from the electronic device, the charging device may compare the value of the electrical power with the value of input power being provided to the charging device.

Based on the comparison, the charging efficiency may be estimated. In one example, the charging device, based on the estimated charging efficiency, may generate an appropriate charging efficiency indication. The charging efficiency indication may be subsequently utilized by a user to adjust a position of the power transmitter within the charging device to increase the charging efficiency. In this manner any user, in the event of the charging efficiency being less than preferred, may adjust the position of the positioning mechanism to increase the charging efficiency of the charging device.

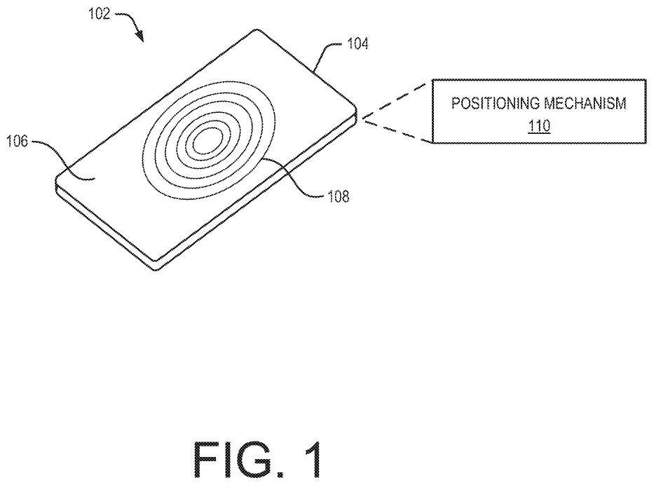

FIG. 1 illustrates an example charging device(s) 102. The charging device(s) 102 allows for wirelessly charging an electronic device (not shown in FIG. 1) when it is placed on, or is in close proximity to, the charging device(s) 102. In the present example, the charging device(s) 102 includes a housing 104. The housing 104 is such that it may encloses a plurality of internal components. For charging, any electronic device may be positioned onto a portion of the housing 104. Such a portion of the housing 104 may be a planar surface, the outer facing surface of onto which an electronic device may be positioned. The planar surface, referred to as a charging surface 106, may be designated onto the housing 104 of the charging device(s) 102. For instance, the charging surface 106 may be a notional position on the housing 104 of the charging device(s) 102 at which the electronic device is positioned for efficient charging. The charging device(s) 102 may further include a cable (not shown in FIG. 1) which may be used for connecting to a power supply.

The charging device(s) 102 further includes a power transmitter(s) 108. The power transmitter(s) 108 within the charging device(s) 102 may be so positioned such that it is present beneath and towards the inner surface of the charging surface 106. In one example, the power transmitter(s) 108 may extend along the inner surface of the charging surface 106. The power transmitter(s) 108 and the charging surface 106 of the charging device(s) 102 are separated by a vertical distance. The charging device(s) 102 may further include a positioning mechanism 110. The positioning mechanism 110 allows adjustment of a position of the power transmitter(s) 108 such that the power transmitter(s) 108 may be brought within the specific range from the charging surface 106 for an electronic device. The position is so adjusted such that the power transmitter(s) 108 may be moved either towards or away from the charging surface 106. As a result, the vertical distance between the power transmitter(s) 108 and a power receiver (not shown in FIG. 1) of the electronic device may either increase or decrease.

The positioning mechanism 110 may be implemented through a variety of mechanisms. In one example, the positioning mechanism 110 may be a mechanical or electro-mechanical. Other types of mechanisms for affecting the change in the position of the power transmitter(s) 108 may also be implemented without deviating from the scope of the present subject matter. The positioning mechanism 110 may be actuated by a user-input or based on specific conditions, as would be explained further in the present description.

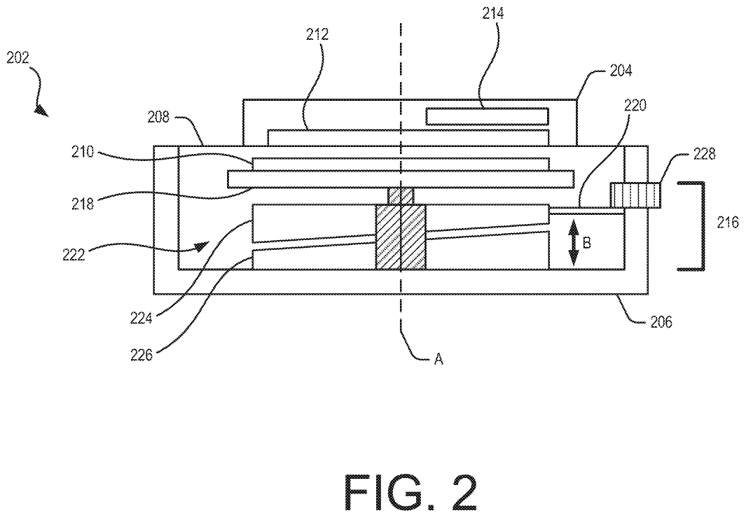

FIG. 2 illustrates another example charging device(s) 202. As illustrated in the present figure, the charging device(s) 202 may be used for charging an electronic device, such as an electronic device(s) 204. The electronic device(s) 204 may be any electronic device which is capable of being charged wirelessly through the charging device(s) 202. Examples of such electronic device(s) 204 include, but are not limited to, computing devices, mobile phones, and personal electronic devices such as shavers, electric toothbrushes, etc. The present list of exemplary electronic device(s) 204 is illustrative and are not be considered as exhaustive—further other types of electronic device(s) 204 may also be utilized without deviating from the scope of the present subject matter.

The charging device(s) 202 may further include a housing, such as the housing 206. The housing 206 may provide an enclosure for internal components of the charging device(s) 202. For charging, the electronic device(s) 204 may be positioned onto a charging surface 208. The charging surface 208 may be a portion of the housing 206. The charging surface 208 may be considered as any designated portion of the housing 206 onto which electronic device(s) 204 may be positioned for charging. Charging may not occur when the electronic device(s) 204 is not positioned within the charging surface 208. In the present example, the charging surface 208 may be considered as a notional position on the housing 206 of the charging device(s) 202 at which power transmitter(s) 210 and secondary coils of an electronic device are optimally aligned. Examples of power transmitter(s) 210 include, but are not limited to, inductive coils, and capacitive elements, and electrodes.

The electronic device(s) 204 may further include power receiver(s) 212, power source(s) 214 coupled to the power receiver(s) 212, and other circuitry (not shown in FIG. 2). Such other circuitry enables the operation of the electronic device(s) 204. The power source(s) 214 is electrically chargeable and provides electrical power to the components of the electronic device(s) 204.

The wireless charging of the electronic device(s) 204 is affected through the power transmitter(s) 210 of the charging device(s) 202. In operation, the power transmitter(s) 210 may generate time varying fields when the charging device(s) 202 is powered on, i.e., connected to an electrical power source. As electrical current passes through the power transmitter(s) 210, a time-varying field is generated. The time-varying field generated by the power transmitter(s) 210 may interact with the power receiver(s) 212. As a result of the interaction between the power transmitter(s) 210 and the power receiver(s) 212 a corresponding electrical current is generated in the power receiver(s) 212. The current in the power receiver(s) 212 is transmitted to, for charging, the power source(s) 214. The power transmitter(s) 210 and the power receiver(s) 212 may be implemented either as respective single or as a combination of multiple elements. Examples of such elements may include, but is not limited to electromagnetic coils, capacitive elements, and electrodes.

As explained previously, efficiency of the charging process may be dependent on the vertical distance, between the power transmitter(s) 210 and the charging surface 208, lying within the specific range. Since the electronic device(s) 204 is placed on the charging surface 208, the charging efficiency may also be considered as dependent on the vertical distance between the power transmitter(s) 210 and the power receiver(s) 212. The vertical distance between the power transmitter(s) 210 and the charging surface 208 (and in turn the power receiver(s) 212 of the electronic device(s) 204) may be adjusted by adjusting a position of the power transmitter(s) 210.

In the present example, a positioning mechanism 216 adjusts the position of the power transmitter(s) 210 such that the vertical distance between the power transmitter(s) 210 and the charging surface 208 may be changed. As illustrated, the positioning mechanism 216 may further include a supporting plate 218 onto which the power transmitter(s) 210 is placed. The supporting plate 218 may be raised or lowered such that the power transmitter(s) 210 may be moved closed or farther, respectively, from the charging surface 208. The positioning of the supporting plate 218 may be implemented through a pinion arrangement 220 and a cam arrangement 222.

The cam arrangement 222 may further include a moveable portion 224 on to which the supporting plate 218 is positioned, and a fixed portion 226. The supporting plate 218 In one example, the moveable portion 224 and the fixed portion 226 have a complimentary profile. The moveable portion 224 is coupled to the pinion arrangement 220 which in turn is connected to a knob 228. As a result, any rotational movement affected through turning the knob 228 rotates the moveable portion 224. In operation, the knob 228 may be manually turned by a user. The turning of the knob 228 further actuates the pinion arrangement 220. The pinion arrangement 220 being coupled to the moveable portion 224 rotates it about an axis A. As the moveable portion 224 rotates over the fixed portion 226, owing to its complimentary shape it moves in a direction B as indicated in FIG. 2. The movement of the moveable portion 224 in the direction B changes the position of the supporting plate 218 and the position of the power transmitter(s) 210, with respect to the charging surface 208. Depending on the direction in which the knob 228 is turned, the supporting plate 218 may be raised or lowered towards the charging surface 208, thereby adjusting the vertical distance between them.

In this manner, the vertical distance between the power transmitter(s) 210 and the charging surface 208 may be adjusted to obtain the specific charging efficiency for charging the electronic device(s) 204. The charging efficiency may be indicated by a charging efficiency value. In one example, the charging efficiency value may be represented as a ratio between the power generated by the power receiver(s) 212 and the value of input power being provided to the charging device(s) 202. In another example, the charging device(s) 202 may be further provided with an indicator to output the charging efficiency value. The indicator may be visual or an audio-based output device.

The positioning mechanism 216, as described, is one of the many possible examples which may be used for adjusting the position of the power transmitter(s) 210 with respect to the charging surface 208. Other arrangement, besides the pinion arrangement 220 and the cam arrangement 222 may also be used. Examples include, but are not limited to, a roller pinion. Any other mechanism for converting an actuating motion to a linear motion of the moveable portion 224 may be used without deviating from the scope of the present subject matter. The extent to which the knob 228 may be adjusted for attaining the optimal charging efficiency for the electronic device(s) 204 under consideration may be determined through an indication mechanism which depicts whether an optimal position of the power transmitter(s) 210, and therefore a specific charging efficiency, has been reached.

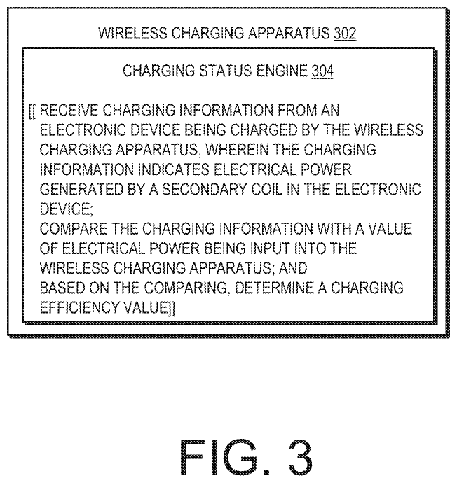

FIG. 3 illustrates a block diagram of a wireless charging apparatus 302. The wireless charging apparatus 302 (or the apparatus 302) further comprises a charging status engine 304. In one example, the charging status engine 304 may receive charging information from an electronic device, such as electronic device(s) 204 (not shown in FIG. 3), which is being charged by the apparatus 302. The charging information may, amongst other aspects, indicate the value of electrical power being generated by the power receiver, such as the power receiver(s) 212 present within the electronic device(s) 204.

Once the charging status engine 304 receives the charging information, it is compared with the value of input electrical being supplied to the apparatus 302. Based on the comparison, the charging status engine 304 determines charging efficiency value. The charging efficiency value may be indicated as a percentage. A higher value of the charging efficiency indicates that the charging is performed efficiently and that the electronic device(s) 204 is positioned optimally onto the apparatus 302. In one example, based on the value of the charging efficiency, the apparatus 302 may generate a visual or an audible indicator to depict to the user whether the electronic device(s) 204 is being charged optimally.

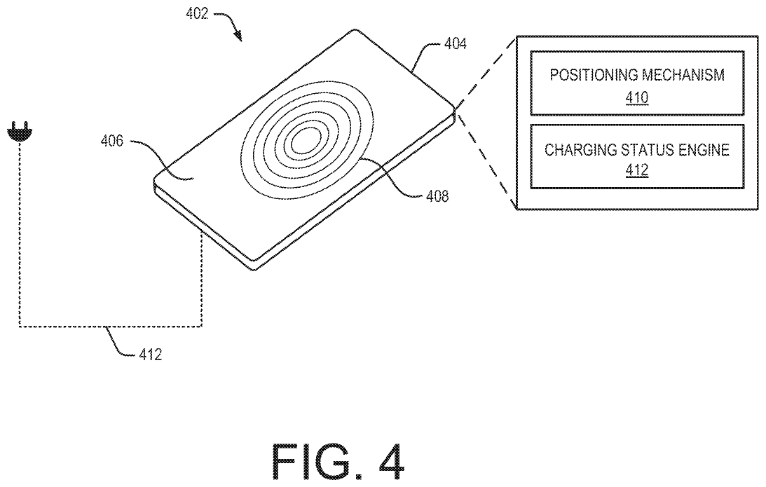

FIG. 4 illustrates a wireless charging station 402. The wireless charging station 402 may be any charging device which is capable of wirelessly charging another electronic device. Examples of such electronic devices include, but is not limited to, computing devices, mobile phones, and personal electronic devices such as shavers, electric toothbrushes, etc. The wireless charging station 402 may have a housing 404 enclosing the internal components and circuitry of the wireless charging station 402. The wireless charging station 402 may include a portion of the housing 404 designated as charging surface 406, for placing an electronic device for charging. Internally, the wireless charging station 402 may further include power transmitter(s) 408, the positioning mechanism 410 and charging status engine 412. The charging surface 106 may be a notional position on the housing 404 of the wireless charging station 402 at which the power transmitter(s) 408 and power receiver, such as power receiver(s) 212, are optimally aligned. The positioning mechanism 410 may be utilized for adjusting a position of the power transmitter(s) 408 with respect to the charging surface 406 of the wireless charging station 402. The position may be adjusted such that the power transmitter(s) 408 may be optimally positioned for a specific charging efficiency.

In operation, the positioning mechanism 410 may be used for adjusting the position of the power transmitter(s) 408 with respect to the charging surface 406. Depending on the change of the position of the power transmitter(s) 408, the perpendicular distance the power transmitter(s) 408 and the charging surface 406 changes accordingly. In one example, the user may ascertain that an electronic device, such as the electronic device(s) 204, is not being charged with certain charging efficiency. In such a case, the user may actuate the positioning mechanism 410 to change the position of the power transmitter(s) 408 causing the perpendicular distance from the charging surface 406 to change. The charging status engine 412, in response to the change in position of the power transmitter(s) 408, may determine a change in a value of charging information obtained from an electronic device being charged. The charging information, in one example, may indicate a value of electrical power generated by a power receiver(s) 212, such as the power receiver in the electronic device. In the present example, with the change in the position of the power transmitter(s) 408, the value of the electrical power being generated by the power receiver(s) 212 may change. Based on the change in the charging information, the charging status engine 412 may accordingly determine a corresponding charging efficiency value. The user may continue to change the position of the power transmitter(s) 408 till a specific charging efficiency value is achieved.

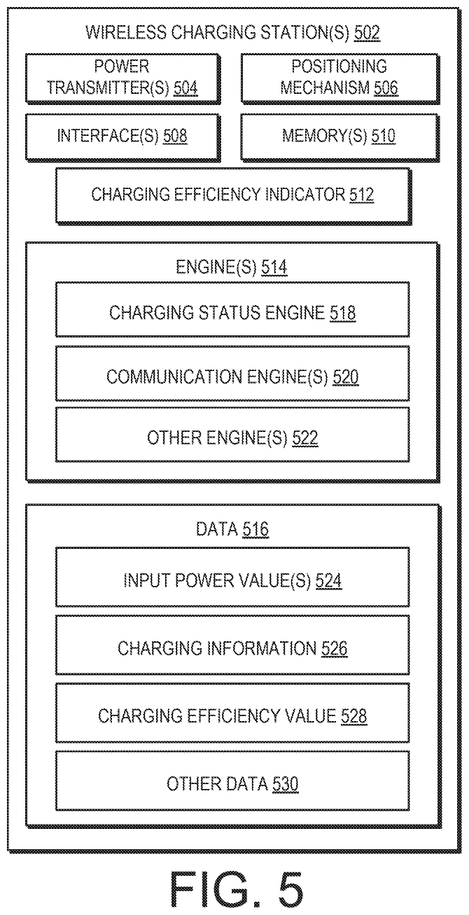

These and other aspects are further described in conjunction with FIG. 5. FIG. 5 illustrates a block diagram of another example wireless charging station 502. The wireless charging station 502 may be any charging device for wirelessly charging another electronic device through electromagnetic induction. In the present example, the wireless charging station 502 may further include a power transmitter(s) 504. The power transmitter(s) 504 may generate time-varying fields which may further interact with a power receiver present within an electronic device. The interaction between the power transmitter(s) 504 and the power receiver (e.g., power receiver(s) 212) generate electric current which may then be used for charging a power source of the electronic device, such as the electronic device(s) 204. Examples of power transmitter(s) 504 include, but are not limited to, inductive coils, and capacitive elements, and electrodes

The wireless charging station 502 may further include positioning mechanism 506, interface(s) 508, a memory 510, charging efficiency indicator 512, engine(s) 514 and data 516. The positioning mechanism 506, as will also be explained later, adjusts a position of the power transmitter(s) 504 with respect to a charging surface 406 of the wireless charging station 502. The interface(s) 508 may include a variety of interfaces, for example, interfaces for data input and output devices, referred to as I/O devices, storage devices, network devices, and the like. The interface(s) 508 facilitate communication between the wireless charging station 502 and the electronic device(s) 204 and provide physical interfaces for coupling the wireless charging station 502 to sources of electrical power. The interface(s) 508 may also be used to communicate signals and other information between a memory 510, charging efficiency indicator 512, engine(s) 514, and data 516.

The memory 510 may store computer-readable instructions, which may be fetched and executed. The memory 510 may include any non-transitory computer-readable medium including, for example, volatile memory such as RAM, or non-volatile memory such as EPROM, flash memory, and the like.

The engine(s) 514 may be implemented as a combination of hardware and programming (for example, programmable instructions) to implement a variety of functionalities of the engine(s) 514. In examples described herein, such combinations of hardware and programming may be implemented in several different ways. For example, the programming for the engine(s) 514 may be processor executable instructions stored on a non-transitory machine-readable storage medium and the hardware for the engine(s) 514 may include a processing resource (for example, either a single processor or a combination of multiple processors), to execute such instructions. In the present examples, the machine-readable storage medium may store instructions that, when executed by the processing resource, implement engine(s) 514. In such examples, the wireless charging station 502 may include the machine-readable storage medium storing the instructions and the processing resource to execute the instructions, or the machine-readable storage medium may be separate but accessible to wireless charging station 502 and the processing resource. In other examples, engine(s) 514 may be implemented by electronic circuitry.

The data 516 includes data that is either stored or generated as a result of functionalities implemented by any of the engine(s) 514. In an example, the engine(s) 514 include charging status engine 518, communication engine(s) 520 and other engine(s) 522. The other engine(s) 522 may implement functionalities that supplement applications or functions performed by the wireless charging station 502 or any of the engine(s) 514. Further, the data 516 may include input power value(s) 524, charging information 526, charging efficiency value 528 and other data 530.

An electronic device, such as the electronic device(s) 204, may be charged wirelessly by the wireless charging station 502. In one example, the electronic device(s) 204 may be brought near, or placed on, the wireless charging station 502. The electronic device(s) 204 may further include power receiver(s) 212, which on interacting with the power transmitter(s) 504 through electromagnetic induction may generate electrical power.

Once the electronic device(s) 204 begins charging, the communication engine(s) 520 may establish a wireless communication channel with the electronic device(s) 204. In one example, the communication channel may be a Bluetooth® or any other wireless communication technology over which the wireless charging station 502 and the electronic device(s) 204 may exchange information. Once the communication channel is established, the communication engine(s) 520 may obtain charging information 526 from the electronic device(s) 204 and then provide it to the charging status engine 518. In one example, the charging information 526 may specify the value of electrical power value generated by the power receiver(s) 212. The charging status engine 518 may further obtain the input power value being provided to the wireless charging station 502. On obtaining the input power value(s) 524 and the charging information 526, the charging status engine 518 determines the charging efficiency value 528. In one example, the charging efficiency value 528 is the ratio of the power value generated by the power receiver(s) 212 and the input power value being provided to the wireless charging station 502.

The charging efficiency value 528 may be output through the charging efficiency indicator 512. In one example, the charging efficiency indicator 512 may be a LED-based display which provides the charging efficiency value 528 as a numerical output, such as percentage. In another example, the charging efficiency indicator 512 may be an audio-output which may generate predefined audio outputs corresponding to the charging efficiency value 528.

A user charging the electronic device(s) 204 may observe the charging efficiency indicator 512 to conclude whether the charging efficiency value 528 is optimal or not. For example, a lower charging efficiency value 528 may indicate that the charging efficiency is not optimal. The user on concluding that the charging efficiency value 528 is low may actuate the positioning mechanism 506 to adjust the position of the power transmitter(s) 504 with respect to a charging surface, such as the charging surface 406.

As the positioning mechanism 506 adjusts the position of the power transmitter(s) 504, the vertical distance from the charging surface 406 may either increase or decrease. During adjusting the position of the power transmitter(s) 504, the charging efficiency indicator 512 indicates the change in the charging efficiency value either visually or audibly. For example, the charging efficiency indicator 512 may indicate the change as either an increasing percentage value on an LED display. Other mechanisms may also be implemented without deviating from the scope of the present subject matter. In either case, the charging efficiency indicator 512 may be monitored to determine whether the charging efficiency value 528 is increasing or decreasing. The user may continue to adjust the position of the power transmitter(s) 504 till a maximum value of the charging efficiency value 528 is achieved.

In one example, the actuation of the positioning mechanism 506 may be affected through an actuator, such as knob 228. In such a case, the knob 228 may be turned in one direction to adjust the position of the power transmitter(s) 504. If the charging efficiency value 528 increases, the user may continue to turn the knob 228 in the same direction till the charging efficiency value 528 reaches a maximum. Conversely, if on turning the knob 228 the charging efficiency value 528 decreases, the user may turn the knob 228 in the reverse direction to check if the charging efficiency value 528 increases. In this manner, the positioning mechanism 506 may be actuated to adjust the position of the power transmitter(s) 504 with respect to the charging surface 406.

Although the above-mentioned example has been described where the positioning mechanism 506 is actuated mechanically, the same may not be construed to be a limitation. The positioning mechanism 506 may be actuated through any electronic, electrical or electro-mechanical mechanism to affect the actuation of the positioning mechanism 506. Furthermore, the positioning mechanism 506 may adjust the position of the power transmitter(s) 504 automatically based on the charging efficiency value 528. On the charging efficiency value 528 being less than the predefined value, the charging status engine 518 may generate executable control instructions for actuating the positioning mechanism 506. The control instructions when executed, say by any one of the engine(s) 514, may actuate the positioning mechanism 506 without any manual intervention. Such example would also be included within the scope of the present subject matter without any limitation. As discussed through the examples, the charging efficiency of a wireless charging station may be increased by adjusting a position of the power transmitter, without changing the structure, design or placement of the power transmitter, nor does it involve changing the structure or design of power receivers in electronic devices.

Although examples for the present disclosure have been described in language specific to structural features and/or methods, it may be understood that the appended claims are not necessarily limited to the specific features or methods described. Rather, the specific features and methods are disclosed and explained as examples of the present disclosure.

We claim:

1. A charging device comprising:
a housing having a charging surface to position an electronic device;
a power transmitter present beneath the charging surface, wherein the power transmitter extends in a plane parallel to the charging surface; and
a positioning mechanism coupled to the power transmitter, wherein the positioning mechanism is to,
adjust a position of the power transmitter to change a perpendicular distance between the plane of the power transmitter and the charging surface.

2. The charging device as claimed in claim 1, wherein the positioning mechanism is one of mechanical and electro-mechanical.

3. The charging device as claimed in claim 1, wherein the positioning mechanism comprises:
a supporting plate onto which the power transmitter is placed;
a cam arrangement coupled to the supporting plate; and
a pinion arrangement coupled to the cam arrangement, wherein actuation of the pinion arrangement affects movement of the supporting plate with respect to the charging surface.

4. The charging device as claimed in claim 3, wherein the cam arrangement further comprises a moveable portion and a fixed portion, with the moveable portion coupled to the supporting plate, wherein actuation of the pinion arrangement affects movement of the moveable portion towards the charging surface.

5. The charging device as claimed in claim 1, wherein the power transmitter comprises an inductive coil.

6. The charging device as claimed in claim 1, further comprising an indicator to indicate a charging efficiency value corresponding to the change in the perpendicular distance between the plane of the power transmitter and the charging surface.

7. The charging device as claimed in claim 6, wherein the indicator is one of a visual indicator and an audio indicator.

8. A wireless charging apparatus comprising:
a charging status engine to:
receive charging information from an electronic device being charged by the wireless charging apparatus, wherein the charging information indicates a value of electrical power generated by a power receiver in the electronic device;
compare the charging information with a value of electrical power being input into the wireless charging apparatus; and
based on comparing, determine a charging efficiency value.

9. The wireless charging apparatus as claimed in claim 8, wherein the charging efficiency value is a ratio between the electrical power generated by the power receiver and the value of electrical power being input into the wireless charging apparatus.

10. The wireless charging apparatus as claimed in claim 8, further comprising a communication engine to establish a wireless communication channel between the wireless charging apparatus and the electronic device, to receive the charging information from the electronic device.

11. A wireless charging station for an electronic device, the wireless charging station comprising:
a housing having a charging surface to position the electronic device;
a positioning mechanism coupled to a power transmitter present beneath the charging surface, with the power transmitter extending along the charging surface, wherein the positioning mechanism is to adjust a position of the power transmitter to change a perpendicular distance between a plane of the power transmitter and the charging surface; and
a charging status engine to:
in response to a change in the perpendicular distance between the power transmitter and the charging surface by the positioning mechanism, determine a change in a value of charging information, wherein the charging information indicates electrical power generated by a power receiver in the electronic device; and
determine a change in a charging efficiency value corresponding to the change in the charging information.

12. The wireless charging station as claimed in claim 11, wherein the positioning mechanism is one of mechanical and electro-mechanical.

13. The wireless charging station as claimed in claim 11, further comprising a charging efficiency indicator indicative of the change in the charging efficiency value, wherein the charging efficiency indicator is one of a visual indicator and an audio indicator.

14. The wireless charging station as claimed in claim 11, wherein the charging status engine is to generate executable control instructions to actuate the positioning mechanism.

15. The wireless charging station as claimed in claim 11, wherein the positioning mechanism is actuated manually by a user.
